(19) United States
(12) Patent Application Publication
(10) Pub. No.: US 2020/0312472 A1
(43) Pub. Date: Oct. 1, 2020

(54) Solid-State Antioxidant for Radioactive Environments

(71) Applicant: SAVANNAH RIVER NUCLEAR SOLUTIONS, LLC, AIKEN, SC (US)

(72) Inventors: AARON L. WASHINGTON, II, AIKEN, SC (US); THANH-TAM T. TRUONG, AIKEN, SC (US); LEROY MAGWOOD, JR., AIKEN, SC (US)

(21) Appl. No.: 16/369,226

(22) Filed: Mar. 29, 2019

(51) Int. Cl. G21F 1/10; G21F 3/00

(52) U.S. Cl. CPC G21F 1/106; C08L 23/06; G21F 3/00

(57) ABSTRACT

Polymeric compositions for use in nuclear applications that exhibit long-lasting protection from degradation in the presence of oxygen (e.g., air) and high energy radiation, even when utilized in high temperature applications are described. The polymeric compositions include a particulate additive that incorporates a zinc-based solid-state antioxidant. The antioxidant can be a binary or ternary zinc-based material that can include one or more additional metals and optionally can include oxygen.

### STATEMENT AS TO RIGHTS TO INVENTIONS MADE UNDER FEDERALLY SPONSORED RESEARCH

This invention was made with Government support under Contract No. DE-AC09-08SR22470 awarded by the United States Department of Energy. The Government has certain rights in the invention.

### BACKGROUND

Polymer degradation is a problem in many industries including food and beverage packaging; the auto industry in use of paint, sealants, and adhesives; the fuel industry in seals and surface treatments; and the paper industry, but can be of critical importance in the nuclear industry. Primary sources of polymer degradation include thermal breakdown and oxidative processes, and the additional degradation source of a radioactive environment can lead to material failure in relatively short order.

In spite of such issues, polymers are ubiquitous throughout nuclear facilities, for instance as seals, piping/tubing, hoses, electrical and thermal insulation, pump/valve components, lubricants, and personal protective equipment, among others. Due to degradation concerns, deactivation and decommissioning (D&D) activities occur relatively frequently in nuclear facilities. D&D leads to the collection of many different types of components and instruments as well as radioactive ores that can emit radiological signals, all of which require handling and packaging behind containment barriers. The containment barriers of choice are also polymer-based and must be replaced at regular intervals prior to material failure.

High performance polymers (e.g., polyether ketones, polyarylene sulfides, liquid crystal polymers, etc.) have been proposed for use in both nuclear facility operations as well as in containment vessels for radioactive materials, but these polymers can be extremely expensive and still exhibit less than desirable degradation characteristics when utilized in a radioactive environment. Lower end polymers such as polyolefins (e.g., polyethylene), polyurethanes, etc. are often utilized for use in such applications, but even with lower base costs, the short life span due to degradation potential leads to an economically undesirable result. For instance, polyethylene aged 100 days at 80° C. in the presence of air experiences a 5% loss in elongation, but the additional exposure to a 5 krad/hr gamma in otherwise identical circumstances leads to a loss of elongation of about 25%. Moreover, under argon, the thermal degradation of polyethylene follows a random scission pathway that has activation energy of about 229 kJ mol⁻¹. However, the activation energy of polyethylene is reduced by about 30% when 1% air is added to the inert argon atmosphere. Even at a lower base cost, such high degradation rates lead to high replacement costs due to such factors.

Various pre-treatment approaches have been attempted to increase the degradation resistance of polymers for use in the nuclear industry to improve stability and lengthen useful lifespan. For instance, polyolefins are often crosslinked to decrease degradation potential. Others have suggested pretreatment of polymer compositions by use of low dose radiation in conjunction with neutralization of free radicals and broken polymer chains thus formed with oxygen in a flowing gas or metal oxides present in the composition. Unfortunately, such options provide limited improvement or, in the case of radiation pre-treatment, are extremely expensive and introduce another level of safety concerns.

What are needed in the art are materials that exhibit increased resistance to degradation in the presence of high energy radiation, and in particular resistance to both radiolytic and thermal degradation events under sustained exposure to oxygen and high energy radiation. Economical containment materials, protective gear, food packaging, paints/coatings, and equipment for use in nuclear facilities that can exhibit such increased resistance would be of great benefit.

### SUMMARY

Aspects and advantages of the invention will be set forth in part in the following description, or may be obvious from the description, or may be learned through practice of the invention.

In one embodiment disclosed is a radiological barrier comprising a polymeric composition. The polymeric composition includes a polymer and a particulate. The particulate can include a solid-state antioxidant that can include zinc, a second metal, and optionally a third component that can be a third metal or can be oxygen. In one embodiment, the solid-state antioxidant can be free of oxygen, e.g., a binary or ternary zinc-based metal alloy. In one embodiment, the polymer has not been processed in a fashion that would encourage the development of binding sites (e.g., radicals) on the polymer.

A radiological barrier that includes the polymeric composition can exhibit excellent resistance to oxidative degradation in the presence of high energy radiation. For instance, the radiological barrier can exhibit a loss in elongation of about 25% or less upon exposure to a gamma radiation dose of 5 krad/hr and upon aging for 100 days at a temperature of 80° C. in the presence of oxygen (e.g., air).

The radiological barrier can be a component of a container that can be utilized to contain radioactive (or potentially radioactive) materials or can be a component of equipment for use in a nuclear facility (e.g., personal protective gear, seals, hoses, insulation, etc.).

Also disclosed are methods for storing radioactive materials that include locating the radioactive materials in a container that includes the radiological barrier, for instance as a layer of the container.

Also disclosed are methods for forming a radiological barrier material that includes blending a polymer with a particulate that includes a solid-state antioxidant as described herein to form a polymeric composition. Beneficially, a method need not include any pre-processing that would encourage the development of binding sites (e.g., radicals) on the polymer so as to encourage chemical interaction between the polymer and the solid-state antioxidant. For instance, a method need not include a pre-treatment of the polymer or the polymeric composition such as radiation pre-treatment, corona discharge, plasma pre-treatment, etc. A method can also include shaping the polymeric composition, for instance via extrusion, blow molding, thermoforming, etc. to form a barrier material having a shape for a desired application.

These and other features, aspects and advantages of the present disclosure will become better understood with reference to the following description and appended claims.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 presents X-ray Diffraction (XRD) patterns for exemplary solid-state antioxidant particles described herein.

FIG. 2 presents scanning electron microscope (SEM) images of ZnO (right) and 2.5% Ba doped ZnO (left) nanoparticles.

FIG. 3 presents thermal gravimetric analysis (TGA) curves for polyethylene and different polyethylene composites.

FIG. 4 presents Kissinger plots obtained by TGA data at different heating rates for polyethylene as well as for various composites of polyethylene.

### DETAILED DESCRIPTION

It is to be understood by one of ordinary skill in the art that the present discussion is a description of exemplary embodiments only, and is not intended as limiting the broader aspects of the present disclosure. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present disclosure is generally directed to polymeric compositions, methods of forming the polymeric compositions, and structures that include the polymeric compositions. The polymeric compositions can provide long-lasting protection from degradation in the presence of oxygen (e.g., air) and high energy radiation, even when utilized in high temperature applications. As utilized herein, the term “high energy radiation” is used interchangeably with “radiation” and is intended to refer to electromagnetic radiation having an energy level equal to or greater than that of X-rays, i.e., about 124 eV or greater. For instance, in one embodiment, the polymeric compositions can provide long-lasting protection from degradation in air in the presence of low dose gamma radiation, e.g., about 5 krad/hour or less. However, the compositions are not limited to such uses and can provide desirable long-lasting barrier characteristics in the presence of higher as well as lower dose radiation.

The long-lasting degradation resistance of the polymer compositions can be evident through examination of any suitable characteristic. For instance, a barrier material that incorporates a polymer composition as disclosed herein can exhibit a loss in elongation of about 25% or less, about 20% or less, about 15% or less, or about 10% or less in some embodiments, upon exposure to a gamma radiation dose of 5 krad/hr and upon aging for 100 days at a temperature of 80° C. in the presence of oxygen (e.g., air). Elongation characteristics can be determined in one embodiment according to ASTM D882 or ASTM D2370.

In addition, disclosed compositions can exhibit excellent thermal stability, and in particular better thermal stability than the same polymer that does not incorporate a solid-state antioxidant as described. Moreover, a polymeric composition as disclosed herein can exhibit an activation energy in an oxygen containing environment that is greater than the activation energy of the pristine polymer of the composition in the same environment (e.g. about 10 kJ mol⁻¹ or more greater, for instance from about 10 kJ mol⁻¹ to about 20 kJ mol⁻¹ greater in some embodiments). For instance, a polymeric composition can exhibit an activation energy in an oxygen containing environment that is about the same as the activation energy of the pristine polymer in argon (e.g., within about 15% or less). In one embodiment, a polymeric composition can exhibit an activation energy in a 1 v/v % air environment of about 200 kJ mol⁻¹ or greater as calculated according to the Kissinger method (Anal. Chem., 1957, 29, 1702-1706, details of which are further described herein).

The degradation resistance of the polymeric composites can be due at least in part to the presence of one or more solid-state antioxidant materials incorporated within the composition. In general, a solid-state antioxidant can be incorporated in a polymeric composition in the form of a particulate additive (i.e., the antioxidant either forming or as a component of a particle). In addition to improving the degradation characteristics of a composition and barrier materials that incorporate the composition, the particulate nature of the solid-state antioxidant additives can also improve the mechanical strength characteristics of the compositions. For instance, the presence of solid-state antioxidant particulates can increase mechanical strength characteristics of a structure that includes the composition (e.g., containers, seals, hoses, etc.) as compared to a similar material that is identical in composition but for the addition of the solid-state antioxidant particulates.

The solid-state antioxidant particulate additives can also mitigate radiation damage across a barrier that includes the composition through shielding. This feature is particularly evident in those embodiments in which the particulates are incorporated into the polymeric compositions at a relatively high density, e.g., about 10 wt. % of the composition or higher. The antioxidant and shielding capabilities of the particulate additives can provide degradation resistance and stability to the polymeric compositions and can extend the life of a structure that incorporates the composition allowing for longer term handling, storage and/or transport.

The antioxidant-containing particles can be micro- or nanoscale particles. For instance, individual microscale particles can generally have a cross sectional dimension of about 500 micrometers or less, about 300 micrometers or less, about 100 micrometers or less, about 50 micrometers or less, or about 10 micrometers or less, in some embodiments. Nanoscale particles can generally have a cross sectional dimension of about 1000 nanometers or less, about 500 nanometers or less, about 300 nanometers or less, about 100 nanometers or less, about 50 nanometers or less, or about 10 nanometers or less in some embodiments. In one embodiment, particulates can include both micro- and nano-scale materials. For instance, micro-scale particles can be surface decorated with nano-scale particles, which can be formed of the solid-state antioxidant. As utilized herein, the term “solid-state” is intended to refer to an inorganic material including, without limitation, metals, metal oxides, semiconductors, metal halides, alloys, etc. Solid-state materials can be in a nano-size range or larger, e.g., nano-sized, micro-sized, or larger, with dimensions in the millimeter or even larger ranges.

The antioxidant materials include zinc-based compounds that include zinc and at least one additional metal. For instance, the antioxidant materials can be binary or ternary compounds that include zinc and at least one additional metal. In one embodiment, an additional metal of an antioxidant compound can include barium (Ba); tungsten (W); lead (Pb); yttrium (Y); zirconium (Zr); a noble metal (ruthenium (Ru), rhodium (Rh), palladium (Pd), silver (Ag), osmium (Os), iridium (Ir), platinum (Pt), gold (Au)); a row 4 transition metal (scandium (Sc), titanium (Ti), vanadium (V), chromium (Cr), manganese (Mn), iron (Fe), cobalt (Co), nickel (Ni), copper (Cu)); or a lanthanide (lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu)).

In those embodiments in which the antioxidant component includes a component in addition to the zinc and the second metal, e.g., is a ternary compound, this additional component of the compound can be a metal or oxygen. In one embodiment, a metal as may be incorporated in an antioxidant as an additional component can include those described above.

Particular antioxidants can include, without limitation, ZnBa, Ba: ZnO, AgI, ZnO, Fe, Ni.

The solid-state zinc-based antioxidant materials can be obtained or formed according to any suitable method. Non-limiting examples of which are described further herein.

The amount of the solid-state antioxidant component in a polymeric composition (which can include one or a combination of different antioxidant materials) can generally depend upon the nature of the polymer component of the composition and on the nature of the desired application. For instance, when considering formation of a flexible polymeric composition as a barrier material, the composition can include a relatively high add-in level of the solid-state antioxidant. For example, a polymeric composition can include the antioxidant component in an amount of about 50 wt. % or less, about 30 wt. % or less, about 20 wt. % or less or about 10 wt. % or less in some embodiments, for instance from about 2 wt. % to about 15 wt. % in some embodiments, or from about 10 wt. % to about 40 wt. % in some embodiments. As discussed previously, a relatively high proportion of the particulate additive (e.g. about 10 wt. % or higher) can also improve radiation shielding characteristics of a structure that incorporates the polymeric composition. However, the polymeric composition is not limited to high antioxidant content, and in other embodiments, a polymeric composition can include relatively low concentrations of the zinc-based antioxidant materials, and still exhibit excellent degradation resistance. For example, in some embodiment, a polymeric composition can include the solid-state antioxidant component in an amount of about 5 wt. % or less, for instance about 4 wt. % or less, about 3.5 wt. % or less, for instance from about 1 wt. % to about 3 wt. % in some embodiments.

The polymer component of the polymeric composition is not particularly limited and, in various embodiments, can include thermoset polymers, thermoplastic polymers, or a combination thereof in either a blend or in a bonded copolymer formation.

In one embodiment, the polymeric composition can include one or more thermoplastic polymers such as, without limitation, polyurethane, polyolefins (e.g., polyethylene, polypropylene), polyvinylchloride, polyvinylpyrrolidone, polyam ides, polyvinyl alcohols, natural latex, ethylene vinyl acetates, polyesters, polyisoprenes, polystyrenes, polysulfones, acrylonitrile-butadiene-styrene, polyacrylates, polycarbonates, polyoxymethylenes, polytetrafluoroethylenes, ionomers, celluloses, polyetherketones, polysiloxanes, polyarylsulfides, liquid crystal polymers, elastomers, copolymers of any of the above, derivatives of any the above, polymer blends, etc.

In one particular embodiment, the polymeric composition can include relatively inexpensive thermoplastic polymers, e.g., polyolefins, polyurethanes, etc. that have been previously not considered highly desirable for use in radioactive environments. For instance, the polymeric composition can include one or more thermoplastic polymers having a glass transition temperature of from about 50° C. to about 130° C. and/or a melt temperature of about 180° C. or less. By way of example, thermoplastic polyolefins including, without limitation, homopolymers or copolymers of polyethylene or polypropylene can be utilized in forming a polymeric composition.

In some embodiments, a polymeric composition can include a thermoset resin based upon one or more thermoset network-forming polymers. When the resin is cured, the resin undergoes an increase in viscosity causing the polymer chains to crosslink and set, such that the resin can no longer flow. This change is not reversible. After curing, the thermoset resin can have a characteristic softening temperature above which the crosslinked resin will soften, but it will not melt on further heating. It will instead deteriorate if the applied temperatures are too high. In some embodiments, a polymeric composition can include a thermoset resin having a softening temperature of from about 50° C. to about 130° C.

A polymeric composition can include one or more thermoset polymers as are generally known in the art. For example, a polymeric composition can include a matrix resin selected from one or more of an epoxide, a polyimide, a bis-maleimide, a polyphenol, a polyester, etc., or combinations thereof that, when fully cured, forms a crosslinked thermoset matrix.

An epoxy, as may be utilized as the matrix resin in a polymeric composition, may suitably comprise epoxy compounds having more than one epoxide group per molecule available for reaction. Such epoxy pre-polymers include, but are not limited to, polyfunctional ethers of polyvalent phenols, for example pyrocatechol; resorcinol; hydroquinone; 4,4′-dihydroxydiphenyl methane; 4,4′-dihydroxy-3,3′-dimethyldiphenyl methane; 4,4′-dihydroxydiphenyl dimethyl methane; 4,4′-dihydroxydiphenyl methyl methane; 4,4′-dihydroxydiphenyl cyclohexane; 4,4′-dihydroxy3,3′-dimethyldiphenyl propane; 4,4′-dihydroxydiphenyl sulphone; or tris-(4-hydroxyphenyl) methane; polyglycidyl ethers of the chlorination and bromination products of the above-mentioned diphenols; polyglycidyl ethers of novolacs (i.e., reaction products of monohydric or polyhydric phenols with aldehydes, formaldehyde in particular, in the presence of acid catalysts); polyglycidyl ethers of diphenols obtained by esterifying 2 moles of the sodium salt of an aromatic hydroxycarboxylic acid with 1 mol of a dihalogenoalkane or dihalogen dialkyl ether; and polyglycidyl ethers of polyphenols obtained by condensing phenols and long-chain halogen paraffins containing at least 2 halogen atoms.

Other suitable polymers include polyepoxy compounds based on aromatic amines and epichlorohydrin, for example N,N′-diglycidylaniline; N,N′-dimethyl-N,N′-diglycidyl-4,4′-diaminodiphenyl methane; N-diglycidyl-4-aminophenyl glycidyl ether; N,N,N′,N′-tetraglycidyl-4,4′-diaminodiphenyl methane; and N,N,N′,N′-tetraglycidyl-1,3-propylene bis-4-aminobenzoate.

Glycidyl esters and/or epoxycyclohexyl esters or aromatic, aliphatic and cycloaliphatic polycarboxylic acids, for example phthalic acid diglycidyl ester and adipic ester diglycidyl and glycidyl esters are also suitable. Glycidyl ethers of polyhydric alcohols, for example of 1,4-butanediol; 1,4-butenediol; glycerol; 1,1,1-trimethylol propane; pentaerythritol and polyethylene glycols may also be used.

A thermoset polymeric composition can include curing/crosslinking agents as are generally known in the art. Such curing agents are well known to those skilled in the art, and include, without limitation polyfunctional carboxylic acids, diols, diamines, and the like. Specific examples of polyfunctional carboxylic acid crosslinking agents can include, without limitation, isophthalic acid, terephthalic acid, phthalic acid, adipic acid, azelaic acid, dicarboxyl dodecanoic acid, succinic acid, maleic acid, glutaric acid, suberic acid, azelaic acid and sebacic acid. Exemplary diols useful as crosslinking agents can include, without limitation, aliphatic diols, aromatic diols, cycloaliphatic diols, and the like. Exemplary diamines that may be utilized as crosslinking agents can include, without limitation, aliphatic diamines, (cyclo)aliphatic diamines, and aromatic diamines.

Conventional additives may be combined with the polymer(s) in forming a polymeric composition to improve the flexibility, strength, durability or other properties of the barrier material and/or to help insure that the barrier material has an appropriate uniformity and consistency. Conventional additives that may be incorporated in a polymeric composition can include, without limitation, impact modifiers, fillers, antimicrobials, lubricants, dyes, pigments or other colorants, traditional antioxidants, stabilizers, surfactants, flow promoters, solid solvents, plasticizers (e.g., epoxy soybean oil, ethylene glycol, propylene glycol, etc.), curing catalysts, nucleators, electrically conductive additives, emulsifiers, surfactants, suspension agents, leveling agents, drying promoters, adhesives, flow enhancers, flame retardants., etc. and other materials added to enhance properties and processibility. In one embodiment, the polymeric composition can include a yellow colorant, which can be utilized to designate possible radiological contamination. Such additives may be employed in a polymeric composition in conventional amounts.

A polymeric composition can generally be formed through combination of one or more polymers with the zinc-based solid-state antioxidant particulate according to standard practice for addition of an additive to a polymeric composition. For instance, a thermoplastic polymer (e.g., polyethylene), a solid-state antioxidant particulate, and any additional additives as desired can be compounded according to standard melt or solution processing techniques. The additives of a composition can be combined with the other components of a composition in any sequence and combination, with preferred additions generally depending upon the specific polymers of the composition.

In one embodiment, the antioxidant particles can be combined with a dispersing aid that can optionally attach to the surface of the particles. The inclusion of dispersing aids may allow higher concentrations of the particles to be incorporated into a composition and avoid agglomeration of the particles during formation of the composition. Suitable dispersing aids include, without limitation, alkoxyorganosilanes, organic acids such as carboxylic acids, alcohols, polyethylene glycols, mono- or di-asters of fatty acids, polyethylene oxide and polypropylene oxide, stearic acid, oleic acid, or combinations thereof. Exemplary alkoxyorganosilanes include octyltriethoxysilane, octadecyltrimethoxysilane, hexadecyltrimethoxysilane, and combinations thereof. Dispersing aids that are coupling agents (i.e., a dispersing aid with two functional groups) may be used. Exemplary coupling agents include methacrylic acid, glycine, glycolic acid, thiolacetic acid, methacryloyloxyethyl acetoacetate, allyl acetoacetate, 3-acryloxypropyltrimethoxysilane, 3-aminopropyltriethoxysilane, 3-mercaptopropyltrimethoxysilane, 3-glycidoxypropyltrimethoxysilane, 7-oct-1-enyltrimethoxysilane, and allyl triethoxysilane. After the addition of a dispersing aid, a slurry can typically have a ratio of dispersing agent to solid-state antioxidant particles of about 0.1 to 6.0 millimole/gram. A slurry can be stirred, generally with heating, until the particles disperse to provide a stable colloid for combination with the polymer(s) of choice.

In one embodiment, the solid-state antioxidant particulates can be uniformly dispersed throughout the polymeric composition. This is not a requirement however, and in some embodiments the solid-state antioxidant particulates can be heterogeneously dispersed throughout the composition.

Beneficially, in one embodiment, the polymeric compositions need not include pre-processing to encourage chemical interaction between the polymers and the solid-state antioxidant particulates. For instance, the polymer compositions need not be subjected to high energy processes (e.g., high energy radiation, corona discharge, plasma treatment, etc.) that would create radicals or other binding sites on the polymers for interaction between the polymers and the solid-state antioxidant particles or other components of the composition. Without wishing to be bound to any particular theory, it is believed that the particular components of the zinc-based antioxidants (i.e., zinc and at least one additional metal) provide desirable degradation resistance to the polymeric compositions even when simply blended into the compositions, with no need for any pre-processing that would encourage chemical interaction (e.g., binding or free radical neutralization) between the polymers and the particles.

In one embodiment, a polymeric composition or a component that incorporates the polymeric composition can include a degradation detection material such as a chromophore that can exhibit a change in photonic emission characteristics and/or a change in color as one or more components (e.g., the chromophore itself) of the layer are degraded. As utilized herein, the term “photonic emission characteristics” generally refers to the photonic emission of a material following excitation of the material. The term “color” generally refers to a natural characteristic of the material and is not dependent upon excitation of the material. Upon degradation of one or more components of the material, a chromophore can exhibit a change in photonic emission characteristics (the emission characteristics following subjection to a defined excitation energy) and can also exhibit a change in the natural color of the chromophore (i.e., the natural color with no excitation energy necessary). Alternatively, a chromophore can exhibit only one of these responses, i.e., either a change in photonic emission characteristics or a change in color.

Examples of suitable degradation detection chromophores as may be incorporated in the materials include vinyl compounds containing substituted and unsubstituted phenyl, substituted and unsubstituted anthracyl, substituted and unsubstituted phenanthryl, substituted and unsubstituted naphthyl, substituted and unsubstituted heterocyclic rings containing heteroatoms such as oxygen, nitrogen, sulfur, or combinations thereof, such as pyrrolidinyl, pyranyl, piperidinyl, acridinyl, quinolinyl. Other chromophores are described in U.S. Pat. No. 6,114,085, and in U.S. Pat. Nos. 5,652,297, 5,763,135, 5,981,145, 6,187,506, 5,939,236, and 5,935,760, which may also be used, and are incorporated herein by reference.

As the polymeric compositions begins to degrade, this can alter the emission spectra and/or the color of the degradation detection chromophore, either through a loss in emission, a change in emission wavelength, or a change in the absorption/reflection characteristics (i.e., the color), depending upon the specific chromophore incorporated, and this alteration can be detected. Suitable detectors can depend upon the nature of the particular chromophore utilized (e.g., the emission wavelength), as is known. For example, in one embodiment, the degradation detection chromophore can emit at a detectable wavelength upon excitation via the alpha particle radiation, and alternation in this emission can be monitored. Alternatively, the barrier material can be monitored by use of an external excitation source (e.g. UV light), and alteration in emission in response to this external source can be monitored.

In one particular embodiment, the degradation detection chromophore can provide a visually detectable signal, and an excitation and/or detection device such as a spectrometer may not be needed. For instance, the degradation detection chromophore can appear to have a certain color or can be clear upon formation of the barrier material, and upon decomposition or radiolysis the chromophore will be chemically altered (e.g., loss of a constituent group) and the visual appearance of the chromophore will change. The alteration in the chromophore upon degradation or radiolysis can be any alteration that leads to a detectable change including, without limitation, loss of a constituent group, crystal structure alteration, oxidation, reduction, etc.

Following formation, a polymeric composition including the antioxidant particulate can be processed to the desired form. The highly stable and efficient degradation resistance provided by the disclosed solid-state antioxidant materials incorporated into a polymeric composition can be utilized in packaging, storage, and handling of radiological material as well as in polymeric components utilized throughout a nuclear facility. The polymeric compositions can provide high stability against radiolysis and polymer degradation combined with effective shielding. Disclosed polymeric compositions can be utilized in a wide variety of applications including short-term containment, personal protective equipment, hoses, seals, lubricants, insulation radiological sensing, long-term material storage, radiological transport, and colorimetric dosimetry, just to name a few.

By way of example, a polymeric composition can be processed to form an extruded or solution cast film formed to have a thickness as is generally known in the art for formation of a storage container, e.g., a containment bag or box. For instance, a polymeric sheet can be formed to a thickness of about 5 mils or greater, about 8 mils or greater, about 12 mils or greater, or about 20 mils or greater in some embodiments. For instance, a polymeric sheet used in formation of a pliable storage bag can have a thickness of from about 5 mils to about 30 mils, in some embodiments.

Of course, a composition can be formed to have any desired form including fibers, sheets, or any other form. In one embodiment, a composition can be in the form of a textile (e.g., a woven, non-woven, or knitted textile) that can include individual fibers formed of the composition. In another embodiment, a polymeric composition can be molded to form a non-pliable structure (e.g., a box, barrel or other shape) designed to contain radioactive materials. Optionally, a polymeric composition can form a single layer of a multi-layered structure, e.g., a barrier layer of a multi-layer containment device.

In other embodiments, a polymeric composition can be utilized in forming personal protective equipment (e.g., gloves, face shields, body suits, etc.), and so forth.

Polymeric components used throughout a nuclear facility can also be formed or processed to include the polymeric composition. For instance, a polymeric seal, hose, etc. can be formed to incorporate the solid-state antioxidant particulate in the composition that forms the device. Alternatively, a component for use in a nuclear facility can be coated with a protective barrier layer that includes the polymeric composite. For example, a polymeric composition in the form of a wrap, a tape or in a fluid form (e.g., as a paint that includes the solid-state antioxidant dispersed within the fluid) can be applied to a surface of a polymeric component and can serve as a radiological barrier layer and provide improved degradation resistance to the component.

The present disclosure may be further understood with reference to the Examples, set forth below

### EXAMPLES

Chemicals were used as received and are listed from supplier as follows. Sigma Aldrich: polyethylene (PE), iron oxide (Fe₂O₃), zinc nitrate hexahydrate, ethylene glycol, barium nitrate, and sodium hydroxide. Buckminsterfullerene were functionalized with lithium borohydride to create a C₆₀:LiBH₄ nanoparticles according to modified literature methods. Briefly, 10 wt. % of LiBH₄ was mixed with C₆₀ and THF in an argon glovebox. The THF was then removed under vacuum and the resultant powder was annealed at 300° C. for 1 h.

Un-doped and doped zinc oxide nanoparticles were formed according to a method in which zinc nitrate-6-hydrate (Zn (NO₃)₂●6 H₂O) was added to 32 mL of deionized water to obtain a Zn²⁺ solution. Afterwards, 4 mL of a base (1M NaOH) was added dropwise (2 min) into the zinc solution with magnetic stirring at room temperature to get a colloid system, which was maintained under stirring for 10 min. Then, the reaction mixture was transferred into a glass vessel for use in a microwave accelerated reaction system (CEM Discovery) and operated at 50 W for a period of 10 minutes. A reaction temperature threshold was set in the program to ensure that the measured reaction temperature did not exceed 100° C. during the reaction.

The structural properties of ZnO and doped-ZnO nanoparticles were investigated by scanning electron microscopy (SEM) and Fourier Transform Infrared (FTIR) spectroscopy. The studies were carried out to determine the chemical composition, light transmission and morphology, respectively. Synthesized ZnO and doped-ZnO powders were also characterized by X-Ray diffraction with a Siemens D500 diffractometer. Diffraction patterns were recorded from 10 to 80° 2θ with a step size of 0.06° at 35 kV and 25 mA. The average crystallite size D (Table 1, below) of the ZnO and doped-ZnO nanostructures were calculated using Scherrer's formula (Equation 1)

$$D = \frac{0.9 λ}{β cos θ} \qquad ( 1 )$$

where λ is the X-ray wavelength of Cu-Kα radiation source, β is the full width at half maximum intensity of the diffraction peak located at 2θ and θ is the Bragg angle.

TABLE 1

| Sample | 2θ Value Along (101) Plane | Crystallite Size D (nm) |
|---|---|---|
| ZnO | 36.1386 | 25.53 |
| 2.5% BaZn | 36.2109 | 26.39 |
| 5.0% BaZn | 36.1245 | 25.32 |

Polyethylene (PE) films were made from linear low-density polyethylene (LLDPE) pellets using a lab-scale extruder, Filabot Original, with a custom-made 1/16 in.×1 in. extruder die. PE composite films were made by combining the additives with 15 g of LLDPE pellets and mixing well to ensure even coating of the LLDPE pellets. The mixture was then poured into the hopper of the extruder and PE films were extruded at 190° C. All the PE strips were then cut into 2 in. pieces and pressed using a Carver press at 2 metric tons and 266° F. for 10 min.

A Perkins Elmer Pyris 1 thermogravimetric analyzer was used for TGA experiments. Decomposition profiles were obtained while heating at 2, 5, 10 and 20° C./min between 50° C. and 600° C. for a sample size of about 15 mg.

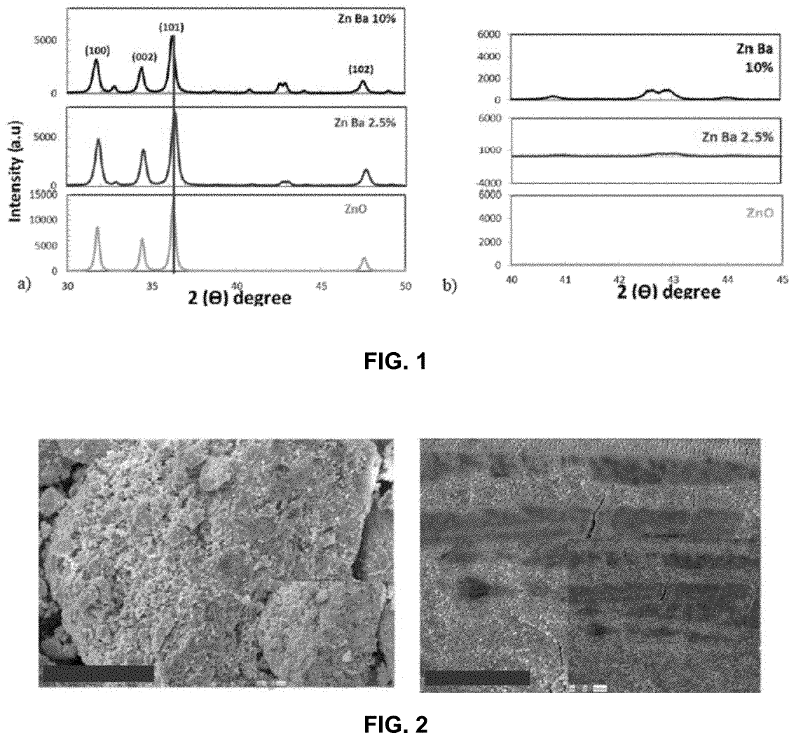

The X-ray diffraction (XRD) spectra of the un-doped and barium doped zinc oxide (ZnO) nanoparticles are shown in FIG. 1. The left panels are at 20 from 30° to 50° and the right panels are at 20 from 40° to 45° . The lower panels show results for the un-doped ZnO nanoparticles, the middle panels show results for the 2.5% Ba-doped nanoparticles, and the upper panels show results for the 10% Ba-doped nanoparticles. As can be seen, all samples exhibit sharp diffraction peaks conforming to (1 0 0), (0 0 2), (1 0 1), (1 0 2) as shown in FIG. 1 while (2 0 0), (1 0 3), (1 1 0) peaks are not shown. The listed diffraction peaks are indicative of a wurtzite hexagonal ZnO structure in conformity with the database of the JCPDS number 36-1451. For neat ZnO particles, no secondary phase was detected in the XRD pattern. However, in the presence of the Ba²⁺ ion, the diffractograms translocated to higher 20 to incorporate the large radius of the Ba atom. The appearance of a secondary phase was noted with the addition of the Ba dopant, indicating an augmentation of the structure as well as incomplete incorporation of the Ba²⁺ at the concentrations tested.

The surface morphologies of the prepared samples were characterized by SEM, as depicted in FIG. 2. The scale bars are 25 micrometers. The SEM images showed differences in the morphology of un-doped and Ba-doped ZnO nanoparticles and nano-structural homogeneities. SEM results also showed that the sintered powders were highly agglomerated, while chemical mapping identified larger concentrations of barium in agglomerated regions.

TGA scans of thermal degradation of the polyethylene films in argon and air were performed and analyzed to determine the sensitivity of the films to oxygen. The scans were taken at a rate of 10° C./min from the range of 50° C.-600° C. In both air and argon, PE degrades in a single step beginning at about 260° C. and ending at about 509° C. and about 523° C., respectively. The onset of the degradation is likely due to the loss of antioxidants in the system followed by loss of small molecular groups at lower temperatures. The degradation of larger molecular groups occurs at higher temperatures.

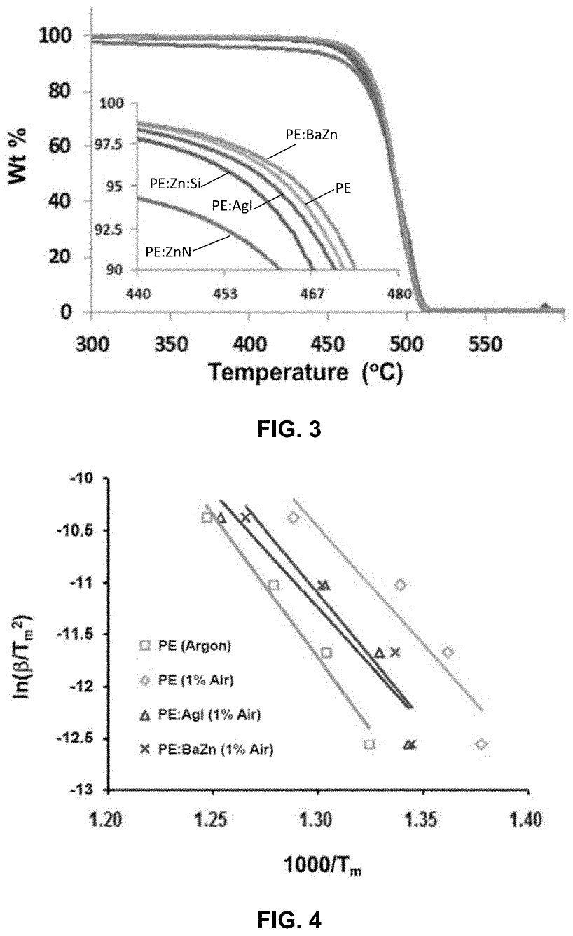

Mass loss of PE and four PE composites at a heating rate of 10° C. min⁻¹ under 1% A air atmosphere are shown in FIG. 3. Doped and un-doped composites show a single degradation phase; however, PE with zinc incorporated shows a slow catalytic degradation that begins at about 200° C. and results in a 5% mass loss before a noticeable loss is noted in PE or other composites samples. To mitigate the impact of catalytic loss of zinc, a blend of zinc and silica was made into a composite blend with PE and showed improvements in the thermal stability of the zinc based composite at levels that are comparable to the Aglion® (hybrid Si blend). Both the PE:Agl and PE:BaZn composites were comparable to the PE degradation curve. For all tested samples, the PE:BaZn composite had a higher curve than the PE and displayed better thermal stability over a wide range of temperatures than other samples.

Activation energy of PE, in both argon and about 1% air, was compared between PE:Agl and PE:BaZn composites, which showed statistical differences from PE in 1% air during thermal degradation. Non-isothermal methods have been used extensively for the determination of kinetic parameters. In this study, the Kissinger method (Anal. Chem., 1957, 29, 1702-1706) was utilized to calculate the activation energies of the PE and PE composite systems.

The conversion rate (dx/dt) of a TGA's dynamic experiment at a constant heating rate of (β) is expressed as Equation 2:

$$\frac{d x}{d t} = \frac{A}{β} {exp}^{ ( \frac{- {E}_{a}}{R T} ) f ( x )} \qquad ( 2 )$$

where: Eₐ is the activation energy of the process,

R is the gas constant (8.314 J mol⁻¹ K⁻¹),

f(x) is the type of functional relation,

T is the absolute temperature (K), and

A is the pre-exponential factor (min⁻¹).

Using this as a background, Kissinger developed a procedure to estimate the activation energy in physical or chemical processes from data of several non-isothermal tests conducted at constant heating rates (constant heating rates for each test; however, the rates were different between tests). Kissinger demonstrated that for a series of non-isothermal tests:

$$\begin{matrix}\frac{β {E}_{a}}{R {T}_{m}^{2}} = - q {k}_{0} exp ( - \frac{{E}_{a}}{R {T}_{m}} ) & ( 3 ) \\ Or & \\ \frac{d ln ( β / {T}_{m}^{2} )}{d ( \frac{1}{{T}_{m}} )} = - \frac{{E}_{a}}{R} & ( 4 )\end{matrix}$$

In equation 4,

β is the rate of heating during testing,

Tₘ is the maximum temperature derived from the DTA curve,

R is the gas constant and

Eₐ is the activation energy.

According to equation 4, a plot of In(β/T²) versus 1/Tₘ leads to a straight line with the slope equal to −Eₐ/R.

FIG. 4 shows the Kissinger plots for the tested systems. PE maintained activation energy of about 229.28 kJ mol⁻¹ in an argon atmosphere; while the PE in air showed activation energy of about 187.81 kJ mol⁻¹. This is >20% decrease in the activation energy. Calculated Eₐ for the PE:Agl and PE:BaZn composites, in an air environment, were 186.23 kJ mol⁻¹ and 202.94 kJ mol⁻¹, respectively. This increase in activation energy approaches the activation energy of pristine PE in argon and suggests the addition of these additives could mitigate thermal degradation of PE composites.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A radiological barrier comprising a polymeric composition, the polymeric composition comprising a polymer and a particulate, the particulate including a solid-state antioxidant comprising zinc and a second metal, wherein the polymer has not been subjected to an energy to form radicals or binding sites on the polymer, the radiological barrier comprising a loss in elongation of about 25% or less upon exposure to a gamma radiation dose of 5 krad/hr and upon aging for 100 days at a temperature of 80° C. in the presence of oxygen.

2. The radiological barrier of claim 1, the second metal being selected from barium, tungsten, lead, yttrium, zirconium, ruthenium, rhodium, palladium, silver, osmium, iridium, platinum, gold, scandium, titanium, vanadium, chromium, manganese, iron, cobalt, nickel, copper, lanthanum, cerium, praseodymium, neodymium, promethium, samarium, europium, gadolinium, terbium, dysprosium, holmium, erbium, thulium, ytterbium, and lutetium.

3. The radiological barrier of claim 1, the solid-state antioxidant further comprising a third metal or oxygen.

4. The radiological barrier of claim 1, the polymer comprising a thermoplastic.

5. The radiological barrier material of claim 4, the thermoplastic having a glass transition temperature of from about 50° C. to about 130° C.

6. The radiological barrier material of claim 1, wherein the radiological barrier material is a component of a storage device.

7. The radiological barrier material of claim 1, wherein the radiological barrier material is a component of a personal protective device or is a component of a nuclear facility system device.

8. A radiological barrier comprising a polymeric composition comprising a polymer and a particulate, the particulate including a solid-state antioxidant comprising zinc and a second metal, wherein the solid-state antioxidant is free of oxygen, the radiological barrier comprising a loss in elongation of about 25% or less upon exposure to a gamma radiation dose of 5 krad/hr and upon aging for 100 days at a temperature of 80° C. in the presence of oxygen.

9. The radiological barrier of claim 8, the second metal being selected from barium, tungsten, lead, yttrium, zirconium, ruthenium, rhodium, palladium, silver, osmium, iridium, platinum, gold, scandium, titanium, vanadium, chromium, manganese, iron, cobalt, nickel, copper, lanthanum, cerium, praseodymium, neodymium, promethium, samarium, europium, gadolinium, terbium, dysprosium, holmium, erbium, thulium, ytterbium, and lutetium.

10. The radiological barrier of claim 8, the solid-state antioxidant further comprising a third metal.

11. The radiological barrier of claim 8, the polymer comprising a thermoplastic.

12. The radiological barrier material of claim 11, the thermoplastic having a glass transition temperature of from about 50° C. to about 130° C.

13. The radiological barrier material of claim 8, wherein the radiological barrier material is a component of a storage device.

14. The radiological barrier material of claim 8, wherein the radiological barrier material is a component of a personal protective device or is a component of a nuclear facility system device.

15. A method for forming a radiological barrier material, the method comprising:
blending a polymer with a particulate to form a polymeric composition, the particulate comprising a solid-state antioxidant comprising zinc and a second metal; and
shaping the polymeric composition; wherein
the method is free from subjection of the polymer to energy that forms radicals on the polymer.

16. The method of claim 15, wherein the solid-state antioxidant is free of oxygen.

17. The method of claim 15, wherein the solid-state antioxidant comprises a third metal or oxygen.

18. The method of claim 15, wherein shaping the polymeric composition comprises extrusion of a melt comprising the polymeric composition.

19. The method of claim 15, wherein shaping the polymeric composition comprises forming a layer that comprises the polymeric composition.

20. The method of claim 15, wherein shaping the polymeric composition comprises crosslinking the polymer.
